(19) United States
(12) Patent Application Publication
(10) Pub. No.: US 2017/0192441 A1
(43) Pub. Date: Jul. 6, 2017

(54) APPARATUSES AND METHODS FOR DIRECTING FLUID

(71) Applicant: TRANSOCEAN SEDCO FOREX VENTURES LIMITED, George Town (KY)

(72) Inventor: Krystian W. Paczkowski, Houston, TX (US)

(21) Appl. No.: 15/283,439

(22) Filed: Oct. 2, 2016

Related U.S. Application Data
(60) Provisional application No. 62/236,291, filed on Oct. 2, 2015.

(51) Int. Cl. G05D 7/01; E21B 41/00

(52) U.S. Cl. CPC G05D 7/0186; E21B 41/00

(57) ABSTRACT

This disclosure includes apparatuses and methods for directing fluid. Some apparatuses include a frame configured to be coupled to a surface of a structure and a plurality of fins configured to be coupled to the frame, each having a width, a length greater than the width, and a bottom surface, wherein, when the frame is coupled to the surface of the structure and the fins are coupled to the frame, the bottom surface of at least one of the fins is angularly disposed at a non-perpendicular angle relative to the surface of the structure such that the fin redirects fluid that contacts the bottom surface of the fin away from the surface of the structure. In some apparatuses, the frame includes a first end and a second end, wherein the first end is configured to be coupled to the surface of the structure such that the second end is free.

### CROSS-REFERENCE TO RELATED APPLICATION

This application claims priority to U.S. Provisional Application No. 62/236,291, filed Oct. 2, 2015 and entitled “DISPERSING GRID WITH ANGLED FLAPS,” the entire of content of which is incorporated herein by reference.

### BACKGROUND

1. Field of Invention

The present invention relates generally to apparatuses and methods for directing fluid.

2. Description of Related Art

An offshore oil rig (e.g., a platform, drillship, and/or the like) may include a moon pool through which equipment can pass into and out of water below the oil rig. Due to movement of water within the moon pool, water contacting sidewalls of the moon pool, bobbing and/or swaying of the oil rig, and/or the like, water from below the oil rig may travel through the moon pool and, for example, overflow and/or splash onto a deck that is adjacent to the moon pool. Such water on the deck may cause damage to equipment, unsafe conditions for operators, and/or the like.

### SUMMARY

Some embodiments of the present apparatuses comprise: a frame configured to be coupled to a surface of a structure, a plurality of fins configured to be coupled to the frame, each of the fins having a width, a length that is greater than the width, and a bottom surface, wherein, when the frame is coupled to the surface of the structure and the fins are coupled to the frame, the bottom surface of at least one of the fins is angularly disposed at a non-perpendicular angle relative to the surface of the structure such that the fin redirects fluid that contacts the bottom surface of the fin away from the surface of the structure. In some apparatuses, for at least one of the fins, the non-perpendicular angle is the smallest angle between the bottom surface of the fin and the surface of the structure, and the non-perpendicular angle is between approximately 10 degrees and approximately 80 degrees. In some apparatuses, when the frame is coupled to the surface of the structure and the fins are coupled to the frame, a bottom edge of at least one of the fins is disposed closer to the surface of the structure than is a top edge of the fin. In some apparatuses, the surface of the structure is substantially vertical.

In some apparatuses, the frame has a first end and a second end, wherein the first end is configured to be coupled to the surface of the structure such that the second end is free. In some apparatuses, the frame comprises a first support rail and a second support rail, each extending between the first and second ends, and each of the fins is configured to be coupled to the frame such that the fin extends between the first support rail and the second support rail.

In some apparatuses, the structure comprises a moon pool. In some apparatuses, the surface of the structure is substantially perpendicular to a deck that is adjacent to the moon pool. In some apparatuses, the bottom surface of at least one of the fins is configured to redirect fluid that contacts the bottom surface of the fin toward a center of the moon pool.

In some apparatuses, at least one of the fins includes one or more protrusions that extend from the bottom surface of the fin. In some apparatuses, at least one of the one or more protrusions of at least one of the fins has a maximum transverse dimension that is between approximately 30 percent and approximately 100 percent of the length of the fin. In some apparatuses, at least one of the one or more protrusions of at least one of the fins has a maximum transverse dimension that is between approximately 5 percent and approximately 25 percent of the length of the fin. In some apparatuses, at least one of the fins defines one or more openings that extend through the fin. In some apparatuses, at least one of the fins is configured to be coupled to the frame such that the fin is rotatable relative to the frame and about a longitudinal axis of the fin.

Some embodiments of the present methods comprise: coupling an apparatus to a sidewall of a moon pool, the apparatus comprising: a frame and a plurality of fins coupled to the frame, each of the fins having a width, a length that is greater than the width, and a bottom surface, wherein the coupling is performed such that the bottom surface of at least one of the fins is angularly disposed at a non-perpendicular angle relative to the surface of the structure such that the fin redirects fluid that contacts the bottom surface of the fin toward a center of the moon pool. In some methods, the non-perpendicular angle is the smallest angle between the bottom surface of the fin and the sidewall of the moon pool, and the non-perpendicular angle is between approximately 10 degree and approximately 80 degrees. In some methods, the coupling is performed such that a bottom edge of at least one of the fins is disposed closer to the sidewall of the moon pool than is a top edge of the fin. In some methods, the sidewall of the moon pool is substantially vertical.

In some methods, the frame has a first end and a second end, and the coupling is performed such that the first end is coupled to the sidewall of the moon pool and the second end is free.

In some methods, at least one of the fins includes one or more protrusions that extend from the bottom surface of the fin and/or one or more openings that extend through the fin. Some methods comprise rotating at least one of the fins relative to the frame to adjust the non-perpendicular angle of the fin.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1 is a perspective view of one embodiment of the present apparatuses, shown coupled to a surface of a structure.

FIG. 2 is a sectional perspective view of the apparatus of FIG. 1.

FIG. 3 is a cross-sectional side view of the apparatus of FIG. 1, taken along line 3-3 of FIG. 1.

FIGS. 4A-4C are perspective, side, and top views, respectively, of a first embodiment of a fin that may be suitable for use in some embodiments of the present apparatuses.

FIGS. 5A-5C are perspective, side, and top views, respectively, of a second embodiment of a fin that may be suitable for use in some embodiments of the present apparatuses.

FIGS. 6A-6C are perspective, side, and top views, respectively, of a third embodiment of a fin that may be suitable for use in some embodiments of the present apparatuses.

FIGS. 7A-7C are perspective, side, and top views, respectively, of a fourth embodiment of a fin that may be suitable for use in some embodiments of the present apparatuses.

FIG. 8 depicts a plurality of apparatuses of FIG. 1 coupled to a sidewall of a moon pool.

### DETAILED DESCRIPTION

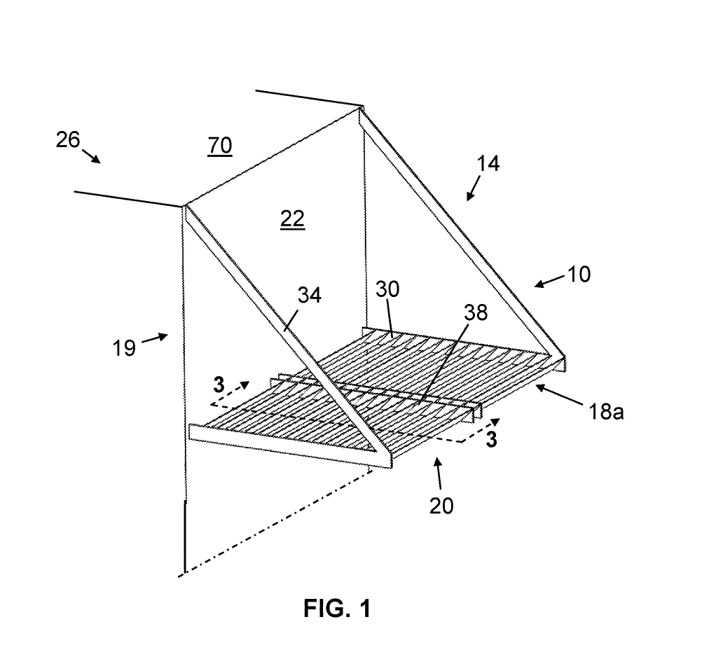

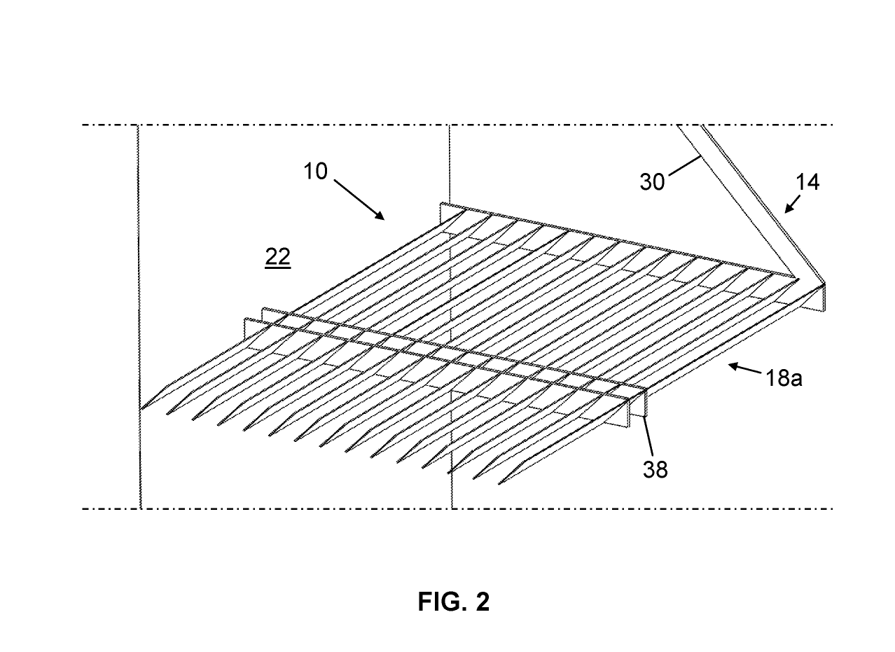

FIGS. 1-3 depict one embodiment 10 of the present apparatuses. Apparatus 10 can comprise a frame 14 configured to support a plurality of fins 18a (described in more detail below). For example, frame 14 can comprise one or more support rails, such as a first support rail 30, a second support rail 34, a third support rail 38, and/or the like, to, across, and/or between which fins 18a can be coupled. Frame 14 can include a first end 19 that is configured to be coupled to a surface 22 of a structure 26. For example, first end 19 of frame 14 can be coupled to structure 26 via the one or more support rails (e.g., through welds, fasteners, and/or the like). Frame 14 can include a second end 20, that, when first end 19 is coupled to structure 26, is free (e.g., is not directly coupled to the structure or any other structure). For example, frame 14 can be supported by structure 26 only on first end 19 of the frame. In at least this way, frame 14 can facilitate placement of fins 18a above fluid that may be adjacent to structure 26.

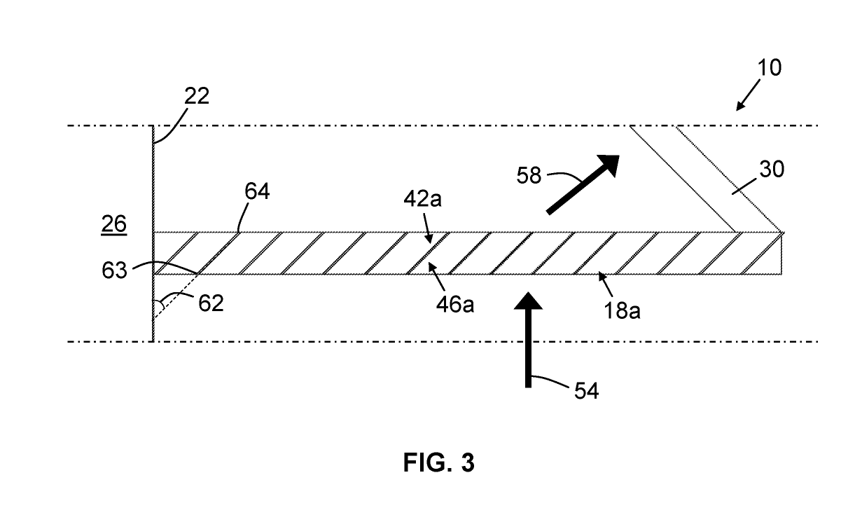

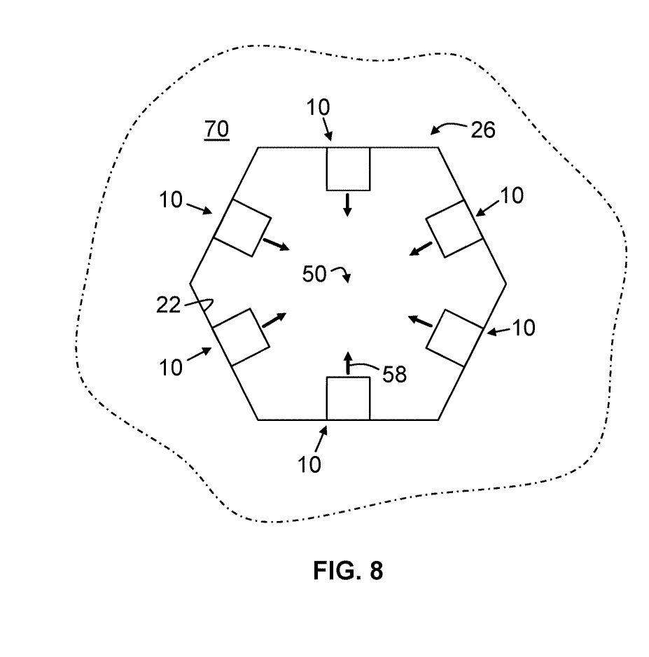

Frame 14 can be coupled to surface 22 of structure 26 such that fins 18a are disposed above a fluid, such as, for example water. Fluid below fins 18a (e.g., in a fluid column that is adjacent to structure 26) may move toward the fins in a generally upward direction (e.g., 54, FIG. 3) due to, for example, movement of the fluid relative to the structure, bobbing and/or swaying of the structure, the fluid contacting the structure, splashing, and/or the like. At least one of fins 18a can be configured such that at least a majority of fluid that contacts the fin is redirected in a direction (e.g., 58) away from structure 26. To illustrate, in this embodiment, structure 26 can comprise a moon pool, surface 22 can comprise a sidewall of the moon pool, and fluid that contacts at least one of fins 18a can be redirected toward a center (e.g., 50, FIG. 8) of the moon pool.

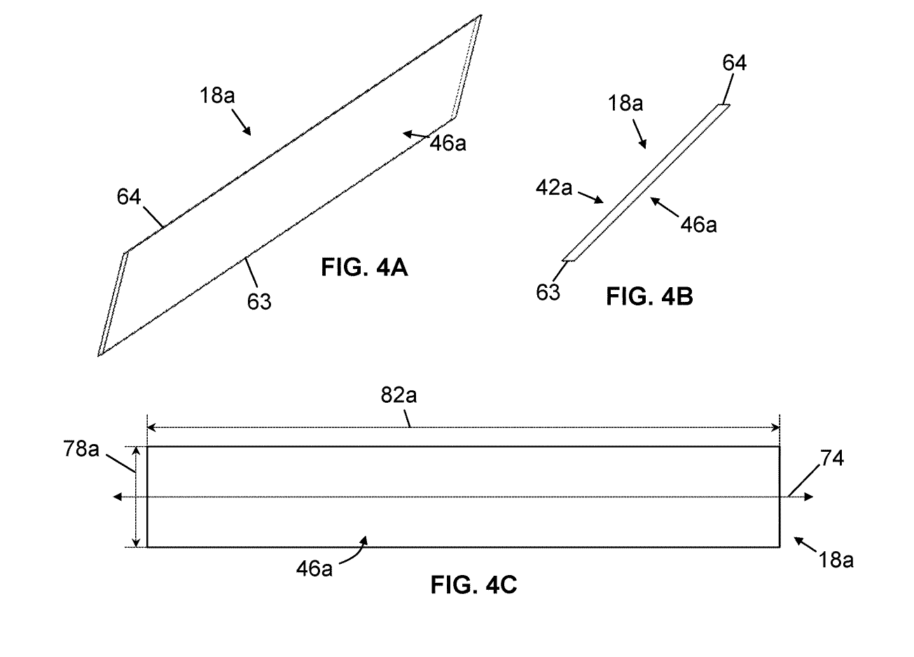

For example, each of fins 18a can have a top surface 42a and a bottom surface 46a. When frame 14 is coupled to surface 22 of structure 26 and fins 18a are coupled to the frame, bottom surface 46a of at least one of fins 18a can be angularly disposed at a non-perpendicular angle 62 relative to the surface of the structure, such that, for example, a bottom edge 63 of the fin is disposed closer to the surface of the structure than is a top edge 64 of the fin. Surface 22 of structure 26 can be substantially vertical; for example, the surface can be substantially perpendicular to a deck (e.g., 70, FIG. 1) that is adjacent to the structure. For at least one of fins 18a, angle 62 can be the smallest angle between bottom surface 46a of the fin and surface 22 of structure 26 and can be approximately any one of, or between any two of, 10, 15, 20, 25, 30, 35, 40, 45, 50, 55, 60, 65, 70, 75, 80, and 85 degrees. Two or more of fins 18a can have different angles 62 such that, for example, the fins can redirect fluid that contacts bottom surfaces 46a of the fins in different directions. At least one of fins 18a can be rotatable relative to frame 14 (e.g., about a longitudinal axis 74 of the fin, which may be aligned with a length 82a of the fin, FIG. 4C) such that angle 62 of the fin can be changed. Such rotation of a fin 18a relative to frame 14 can be accomplished via, for example, a pivotal coupling between the fin and the frame (e.g., at least one of the one or more support rails of the frame).

Referring to FIGS. 4A-4C, shown is fin 18a. Fin 18a can have a width 78a and a length 82a that is greater than the width. For example, width 78a can be between approximately 2 centimeters (cm) and approximately 30 cm (e.g., approximately 2, 4, 6, 8, 10, 12, 14, 16, 18, 20, 22, 24, 26, 28, or 30 cm), and length 82a can be between approximately 10 cm and approximately 600 cm (e.g., approximately 10, 15, 20, 25, 30, 35, 40, 45, 50, 60, 70, 80, 90, 100, 125, 150, 200, 250, 300, 350, 400, 450, 500, and 600 cm). For further example, width 78a can be less than or equal to any one of, or between any two of, 10, 15, 20, 25, 30, 35, 40, 45, 50, 55, 60, 65, 70, 75, 80, 85, or 90% (e.g., approximately 15%) of length 82a.

At least a portion of top surface 42a and/or bottom surface 46a of fin 18a can be substantially planar. In other embodiments, at least a portion of a top surface (e.g., 42a) and/or a bottom surface (e.g., 46a) of a fin (e.g., 18a) can be non-planar (e.g., curved, concave, convex, and/or the like). Top surface 42a and/or bottom surface 46a of fin 18a can include a smooth portion and/or a textured portion.

Fin 18a can comprise a flexible and/or resilient portion (e.g., comprising a flexible and/or resilient material, such as, for example, a plastic, a rubber, and/or the like, and/or a flexible and/or resilient structure) and/or a rigid portion (e.g., comprising a rigid material and/or structure). Fin 18a can include a solid portion (e.g., having a cross-section that is free of voids) and/or a hollow portion (e.g., having a cross-section that defines an interior volume). Fin 18a can comprise a corrosion-resistant material, such as, for example, aluminum, steel, titanium, a plastic, a rubber, and/or the like.

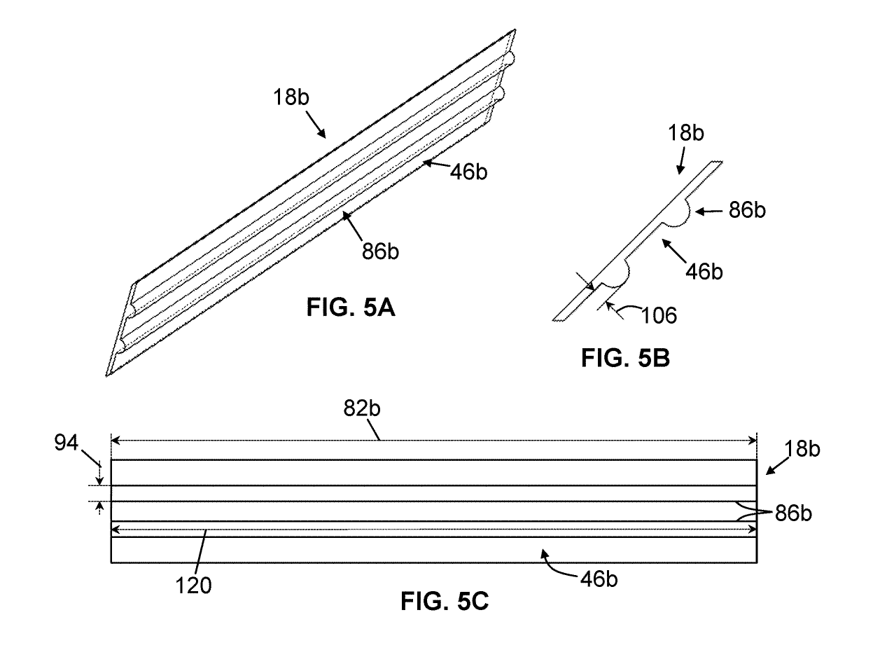

Referring to FIGS. 5A-5C, shown is a second embodiment 18b of the present fins that may be suitable for use in some embodiments (e.g., 10) of the present apparatuses. Fin 18b can be substantially similar to fin 18a, with the primary exceptions described below. Fin 18b can include one or more protrusions 86b that extend from a bottom surface 46b of the fin. At least one of protrusion(s) 86b can be elongated. For example, at least one of protrusion(s) 86b can have a width 94 that is less than or equal to any one of, or between any two of, 5, 10, 15, 20, or 25% of a length 120 of the protrusion. For fin 18b, at least one of protrusion(s) 86b can extend across a majority of (e.g., up to and including all of) a length 82b of the fin; for example, length 120 of the protrusion can be greater than or equal to any one of, or between any two of, 55, 60, 65, 70, 75, 80, 85, 90, 95, or 100% of the length of the fin.

Width 94 of at least one of protrusion(s) 86b can be substantially constant along length 120 of the protrusion, as shown in FIG. 5C. In some embodiments, at least one of protrusion(s) (e.g., 86b) of a fin (e.g., 18b) can have a width (e.g., 94) that varies along a length (e.g., 120) of the protrusion such that, for example, at least a portion of the protrusion has a cross-section, taken parallel to a bottom surface (e.g., 46b) of the fin, that includes a circular, elliptical, or otherwise rounded portion and/or a triangular or otherwise polygonal portion. Each of protrusion(s) 86b of fin 18b has a height 106 (e.g., measured from bottom surface 46b of the fin). For example, for at least one of protrusion(s) 86b, height 106 can be approximately any one of, or between any two of, 0.5, 1.0, 1.5, 2.0, 2.5, 3.0, 3.5, 4.0, 4.5, 5.0, 6.0, 7.0, 8.0, 9.0, or 10.0 cm. For at least one of protrusion(s) 86b, height 106 can be less than, approximately equal to, or greater than width 94 (e.g., the height can be greater than any one of, or between any two of, 5, 10, 15, 20, 25, 30, 40, 50, 60, 70, 80, 100, 120, 140, 160, 180, 200, 250, or 300% of the width).

At least one of protrusion(s) 86b can include a substantially straight portion, such as, for example, a portion that follows a substantially straight line along fin 18b, whether that line is substantially aligned with or is angularly disposed relative to longitudinal axis 74 of the fin. In some embodiments, a protrusion (e.g., 86b) of a fin (e.g., 18b) can include a curved portion (e.g., a portion that follows a curved line along the fin). At least one of protrusion(s) 86b can be rounded; for example, the protrusion can have a cross-section having a circular, elliptical, or otherwise rounded portion (e.g., FIG. 5B). In some embodiments, a protrusion (e.g., 86b) can have a cross-section having a triangular, square, rectangular, or otherwise polygonal portion.

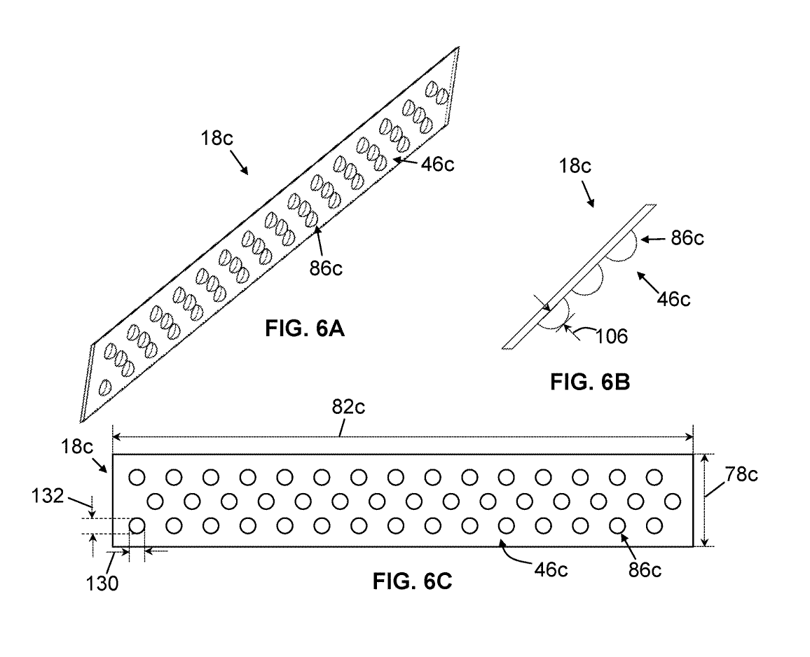

Referring to FIGS. 6A-6C, shown is a third embodiment 18c of the present fins that may be suitable for use in some embodiments (e.g., 10) of the present apparatuses. Fin 18c can be substantially similar to fin 18a, with the primary exceptions described below. Fin 18c can include one or more protrusions 86c that extend from a bottom surface 46c of the fin. At least one of protrusion(s) 86c of fin 18c can comprise a first transverse dimension 130, measured along length 82c of the fin, and a second transverse dimension 132, measured along width 78c of the fin. For at least one of protrusion(s) 86c of fin 18c, first transverse dimension 130 and/or second transverse dimension 132 can be less than or equal to any one of, or between any two of, 5, 10, 15, 20, 25, 30, 35, 40, 45, 50, 55, 60, 65, or 70% of width 78c of the fin (e.g., between approximately 15% and approximately 20% of the width). Second transverse dimension 132 can be substantially equal to first transverse dimension 130. For at least one of protrusion(s) 86c, a height 106 of the protrusion can be less than, approximately equal to, or greater than first transverse dimension 130 and/or second transverse dimension 132 (e.g., the height can be greater than or equal to any one of, or between any two of, 5, 10, 15, 20, 25, 30, 40, 50, 60, 70, 80, 100, 120, 140, 160, 180, 200, 250, or 300% of the first and/or second transverse dimensions).

At least one of protrusion(s) 86c of fin 18c can have a cross-section, taken perpendicular to a bottom surface 46c of the fin, and/or a cross-section, taken parallel to the bottom surface of the fin, that includes a rounded (e.g., circular) portion. In some embodiments, such cross-section(s) can include a circular, elliptical, or otherwise rounded portion and/or a triangular, square, rectangular, or otherwise polygonal portion. For fin 18c, at least one of protrusion(s) 86c can comprise a spherical outer surface. In some embodiments, a protrusion (e.g., 86c) can comprise an ellipsoidal, cylindrical, or prismatic outer surface.

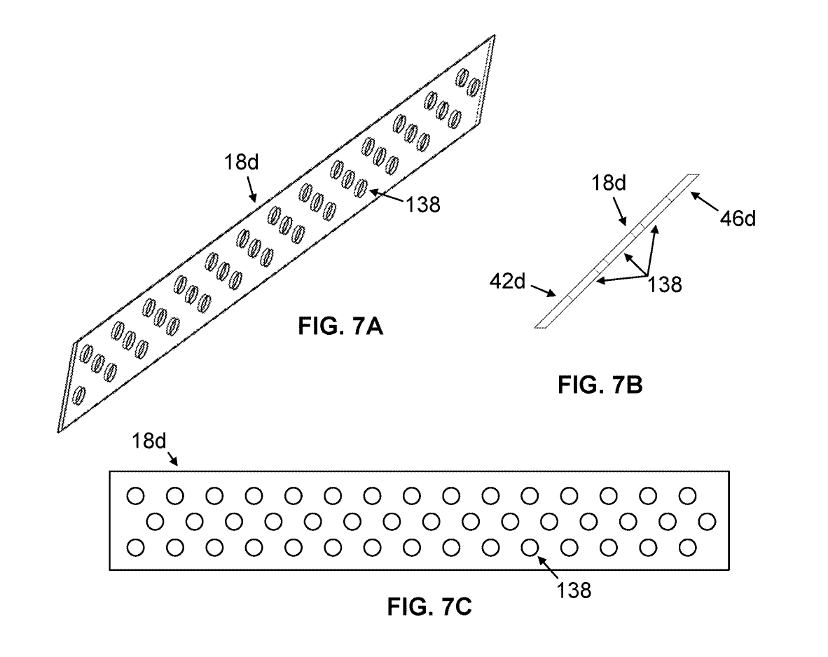

Referring to FIGS. 7A-7C, shown is a fourth embodiment 18d of the present fins that may be suitable for use in some embodiments (e.g., 10) of the present apparatuses. Fin 18d can be substantially similar to fin 18a, with the primary exceptions described below. Fin 18d can define one or more openings 138. At least one of opening(s) 138 can extend through fin 18d (e.g., through bottom surface 46d and top surface 42d) and/or at least one of opening(s) 138 can extend into (e.g., into the bottom surface), but not through, the fin, such that, for example, the opening can be characterized as a recess. At least one of opening(s) 138 can be rounded (e.g., circular). In some embodiments, at least one of opening(s) (e.g., 138) can be elliptical or otherwise rounded, or triangular, square, rectangular, or otherwise polygonal. In some embodiments, opening(s) (e.g., 138) may be defined by a mesh or screen that defines at least a portion of or is coupled to a fin (e.g., 18d).

A fin (e.g., 18a, 18b, 18c, 18d, and/or the like) of the present disclosure can include any combination of protrusion(s) (e.g., 86b and/or 86c) and/or opening(s) (e.g., 138). The present apparatuses (e.g., 10) can each include any combination of fins (e.g., 18a, 18b, 18c, 18d, and/or the like).

Provided by way of illustration, FIG. 8 depicts a moon pool (e.g., structure 26) including a plurality of the present apparatuses (e.g., 10) coupled to a sidewall (e.g., surface 22) of the moon pool. As shown, the plurality of apparatuses 10 can be configured to redirect fluid that contacts fin(s) (e.g., 18a, 18b, 18c, 18d, and/or the like) of the apparatus(es) toward a center 50 of the moon pool and/or away from a deck 70 that is adjacent to the moon pool.

Some embodiments of the present methods comprise: coupling an apparatus (e.g., 10) to a sidewall (e.g., surface 22) of a moon pool (e.g., structure 26), the apparatus comprising a frame (e.g., 14) and a plurality of fins (e.g., 18a, 18b, 18c, 18d, and/or the like) coupled to the frame, each of the fins having a width (e.g., 78a), a length (e.g., 82a) that is greater than the width, and a bottom surface (e.g., 46a), wherein the coupling is performed such that the bottom surface of at least one of the fins is angularly disposed at a non-perpendicular angle (e.g., 62) relative to the surface of the structure such that the fin redirects fluid that contacts the bottom surface of the fin toward a center of the moon pool (e.g., 50). In some methods, the non-perpendicular angle is the smallest angle between the bottom surface of the fin and the sidewall of the moon pool, and the non-perpendicular angle is between approximately 10 degree and approximately 80 degrees. In some methods, the coupling is performed such that a bottom edge (e.g., 63) of at least one of the fins is disposed closer to the sidewall of the moon pool than is a top edge (e.g., 64) of the fin. In some methods, the sidewall of the moon pool is substantially vertical.

In some methods, the frame has a first end (e.g., 19) and a second end (e.g., 20), and the coupling is performed such that the first end is coupled to the sidewall of the moon pool and the second end is free.

In some methods, at least one of the fins includes one or more protrusions (e.g., 86b, 86c, and/or the like) that extend from the bottom surface of the fin and/or one or more openings (e.g., 138) that extend through the fin. Some methods comprise rotating at least one of the fins relative to the frame to adjust the non-perpendicular angle of the fin.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. An apparatus comprising:
a frame having:
a first end; and
a second end;
wherein the first end is configured to be coupled to a surface of a structure such that the second end is free; and
a plurality of fins configured to be coupled to the frame, each of the fins having:
a width;
a length that is greater than the width; and
a bottom surface;
wherein, when the frame is coupled to the surface of the structure and the fins are coupled to the frame, the bottom surface of at least one of the fins is angularly disposed at a non-perpendicular angle relative to the surface of the structure such that the fin redirects fluid that contacts the bottom surface of the fin away from the surface of the structure.

2. The apparatus of claim 1, wherein, when the frame is coupled to the surface of the structure and the fins are coupled to the frame, a bottom edge of at least one of the fins is disposed closer to the surface of the structure than is a top edge of the fin.

3. The apparatus of claim 1, wherein the structure comprises a moon pool.

4. The apparatus claim 3, wherein the surface of the structure is substantially perpendicular to a deck that is adjacent to the moon pool.

5. The apparatus of claim 3, wherein the bottom surface of at least one of the fins is configured to redirect fluid that contacts the bottom surface of the fin toward a center of the moon pool.

6. The apparatus of claim 2, wherein the surface of the structure is substantially vertical.

7. The apparatus of claim 1, wherein at least one of the fins includes one or more protrusions that extend from the bottom surface of the fin.

8. The apparatus of claim 7, wherein at least one of the one or more protrusions of at least one of the fins has a maximum transverse dimension that is between approximately 30 percent and approximately 100 percent of the length of the fin.

9. The apparatus of claim 7, wherein at least one of the one or more protrusions of at least one of the fins has a maximum transverse dimension that is between approximately 5 percent and approximately 25 percent of the length of the fin.

10. The apparatus of claim 1, wherein at least one of the fins defines one or more openings that extend through the fin.

11. The apparatus of claim 1, wherein at least one of the fins is configured to be coupled to the frame such that the fin is rotatable relative to the frame and about a longitudinal axis of the fin.

12. The apparatus of claim 1, wherein:
the frame comprises a first support rail and a second support rail, each extending between the first and second ends; and
each of the fins is configured to be coupled to the frame such that the fin extends between the first support rail and the second support rail.

13. The apparatus of claim 1, wherein, for at least one of the fins:
the non-perpendicular angle is the smallest angle between the bottom surface of the fin and the surface of the structure; and
the non-perpendicular angle is between approximately 10 degrees and approximately 80 degrees.

14. A method comprising:
coupling an apparatus to a sidewall of a moon pool, the apparatus comprising:
a frame; and
a plurality of fins coupled to the frame, each of the fins having:
a width;
a length that is greater than the width; and
a bottom surface;
wherein the coupling is performed such that the bottom surface of at least one of the fins is angularly disposed at a non-perpendicular angle relative to the surface of the structure such that the fin redirects fluid that contacts the bottom surface of the fin toward a center of the moon pool.

15. The method of claim 14, wherein the coupling is performed such that a bottom edge of at least one of the fins is disposed closer to the sidewall of the moon pool than is a top edge of the fin.

16. The method of claim 14, wherein:
the frame has:
a first end; and
a second end; and
the coupling is performed such that the first end is coupled to the sidewall of the moon pool and the second end is free.

17. The method of claim 14, comprising rotating at least one of the fins relative to the frame to adjust the non-perpendicular angle of the fin.

18. The method of claim 14, wherein, for at least one of the fins:
the non-perpendicular angle is the smallest angle between the bottom surface of the fin and the sidewall of the moon pool; and
the non-perpendicular angle is between approximately 10 degrees and approximately 80 degrees.

19. The method of claim 15, wherein the sidewall of the moon pool is substantially vertical.

20. The method of claim 14, wherein at least one of the fins includes:
one or more protrusions that extend from the bottom surface of the fin; and/or
one or more openings that extend through the fin.
